(19) United States
(12) Patent Application Publication
(10) Pub. No.: US 2006/0062177 A1
(43) Pub. Date: Mar. 23, 2006

(54) Apparatus, and an associated method, for communicating data in header-reduced form

(76) Inventors: Sarvesh Asthana, San Diego, CA (US); Sreenivas Addagatla, San Diego, CA (US); Clara Nghia Ly, McKinney, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/146,888

(22) Filed: Jun. 7, 2005

Related U.S. Application Data
(60) Provisional application No. 60/577,543, filed on Jun. 7, 2004.

(51) Int. Cl. H04Q 7/00

(52) U.S. Cl. 370/328

(57) ABSTRACT

Apparatus, and an associated method, for communicating data pursuant to a communication session, such as a VoIP communication session between communication endpoint nodes in header-reduced form. Header reduction is performed at the communication endpoint nodes, obviating the need for the operations to be performed at the network. A reservation request message is generated at the communication endpoint nodes, and a mapping is formed by a mapper at the network part. The mapping is used to cause routing of the data packets in the header-reduced form between the communication endpoint nodes.

### CROSS-REFERENCE TO RELATED APPLICATION

The present invention claims the priority of U.S. Provisional Patent Application of Ser. No. 60/577,543, filed on Jun. 7, 2004, the contents of which are incorporated herein by reference.

The present invention relates generally to the communication of data between endpoint nodes, such as data communicated pursuant to a VoIP communication session between mobile terminals of a radio communication system. More particularly, the present invention relates to apparatus, and an associated method, by which to communicate the data in header-reduced

Header reduction is delegated to the endpoint nodes. Once the data is placed into the header-reduced form at an originating endpoint node, the data is communicated to a terminating endpoint node by way of a network. Because data is placed in the header-reduced form prior to its communication through the network, network elements are not required to perform header reduction operations.

### BACKGROUND OF THE INVENTION

Advancements in digital communication techniques have permitted the development and deployment of digital communication systems capable of communicating large amounts of data in short periods of time. Various different types of communication systems have been developed and deployed that make use of digital communication techniques.

A communication system provides for the effectuation of communication between a set of communication endpoints. In a wireline communication system, wireline connections interconnect the communication endpoints that are parties to a communication session. In contrast, a radio communication system makes use of radio channels for at least a portion of the communication path extending between the communication endpoints.

Due to use of radio channels upon which to communicate data between the communication endpoints, communications are sometimes effectuable by way of a radio communication system even when corresponding communications would not be possible by way of a wireline communication system.

A cellular communication system is a type of radio communication system. Successive generations of cellular communication systems have been developed and deployed, generally now making use of digital communication techniques. While earlier-generation, cellular communication systems generally provided for relatively limited data communication services, newer-generation, cellular communication systems provide for increasingly data-intensive data communication services at increasingly greater rates.

When digital communication techniques are utilized, the data that is to be communicated is generally formatted into packets, and, once formed, the packets are communicated to effectuate the communication of the data. Formatting of the data at different logical levels is carried out in conformity with standard protocols. A data packet generally includes a header part and a payload part. The payload part forms the informational part of the packet, and the header part forms the control part of the packet. The control information is populates the control part of the data packet. When the data packet forms an Internet Protocol (IP) data packet, the control information populating the header part of the packet includes routing information identifying the terminating endpoint as well as the originating endpoint at which the data packet is formed.

When communications are effectuated, such as a VoIP (Voice over Internet Protocol) communication service, is carried out between a set of endpoints, significant numbers of data packets are typically communicated between the set of endpoints. And, in a multi-user communication system, a plurality of separate communication sessions are concurrently carried out, each communication session of which communicating a plurality of data packets. The amount of control information forming the header parts of the data packets becomes significant. The information-bearing capacity of the communication system is limited.

Header-reduction mechanisms have been set forth by which to compress, or remove, header parts of data packets that are communicated pursuant to a communication session between endpoints. For instance, mechanisms have been proposed for header reduction of data packets communicated between communication endpoints of a cellular communication system operable in conformity with the IS-835C operating specification promulgated by the TIA/EIA. In a proposed mechanism, network-located routing nodes, e.g., PDSNs (Packet Data Service Nodes), undertake header reduction operations to remove or compress the header parts of data packets. The header reduction or compression places data in header reduced or compressed form pursuant to service options defined in the IS-835C operating specification to allow for the efficient transport of VoIP data without the overhead that would be present from PPP and RLP (Radio Link Protocol) framing on ordinary packet data services. Service options 60 and 61 support header removal and link-layer assisted (LLA) robust header compression and corresponding decompression.

However, the existing mechanism in which the header reduction is performed slowly at the network introduces delays in communications due to the need to perform processing at a limited number of the routing nodes, such as the originating and terminating routing nodes. The existing mechanism suffers scalability constraints due to the finite capabilities of the PDSNs forming the routing nodes.

An improved mechanism by which to place data in header-reduced form to facilitate communications without requiring the header operations to be performed at a limited number of originating and terminating routing nodes would, therefore, be advantageous.

It is in light of this background information related to communication of data in header-reduced form that the significant improvements of the present invention have evolved.

### SUMMARY OF THE INVENTION

The present invention, accordingly, advantageously provides apparatus, and an associated method, for facilitating communication of data, such as data communicated pursuant to a VoIP communication session, between endpoint nodes of a communication system, such as a cellular communication system in conformity with an IS-835C operating specification.

Through operation of an embodiment of the present invention, a manner is provided by which to communicate the data in header-reduced form. Through the communication of the data in the header-reduced form, improved communication efficiency is possible as the header parts of data packets that are communicated pursuant to a communication session between communication endpoints are of compressed header parts or are free of header parts.

In contrast to an existing mechanism in which header reduction is performed at originating and terminating routing nodes through which data packets are communicated to communication endpoints, in an embodiment of the present invention, header reduction is delegated to the endpoint nodes. Once the data is placed into the header-reduced form at an originating endpoint node, the data is communicated to a terminating endpoint node by way of a network. Because the data is placed in the header-reduced form prior to its communication through the network, network elements are not required to perform header-reduction operations.

In one aspect of the present invention, a reservation request message is generated at an endpoint node, such as a mobile terminal operable in the IS-835C-compliant cellular communication system. The reservation request message identifies an address of the endpoint node and identifies the endpoint node either to be a header reduction originator or an endpoint reduction terminator. When the endpoint node forms an IS-835C-compliant mobile terminal, the reservation request message forms an RSVP RESV request, similar to that defined in the IS-835C operating specification, but with a new treatment field that is populated with a value to identify the mobile terminal either to be an end-to-end header reduction originator or an end-to-end header reduction terminator.

The address contained in the reservation request message that identifies the endpoint node comprises, for instance, an Internet Protocol (IP) address assigned to the endpoint node. The Internet Protocol address is assigned to the endpoint, e.g., for the duration of a communication session. The IP address is assigned to the endpoint as part of an SIP (Session Interface Protocol) SDP (Service Data Point) exchange, and the value of the IP address is available at the endpoint when the reservation request message is generated.

In another aspect of the present invention, the reservation request message also includes a service reference identifier, such as an SR_ID value. The service reference identifier identifies a service instance over which data traffic shall be communicated, i.e., exchanged, pursuant to a communication session. The reservation request message thereby identifies the endpoint, the service instance that shall be used pursuant to the communication session, and an indication of the endpoint as being an originator or terminator.

In another aspect of the present invention, the reservation request message is sent to the network part of the communication system and provided to an appropriate routing node, i.e., an originating routing node or a terminating routing node. Again, in an IS-835C-compliant system, the routing node forms a PDSN. The routing node evaluates the reservation request message and, in response, generates a reservation confirmation message when the routing node is able to find such an information, such as the RP session information, associated with the endpoint and communication resources are available pursuant to the communication request.

The endpoint further includes a detector that detects the reservation confirmation message returned thereto by the routing node.

Another endpoint that is to be a party to the communication session correspondingly also generates a reservation request message for delivery to a routing node. And, the routing node returns a reservation confirmation message.

The endpoints of the communication session thereafter set up context states therebetween for the transfer of communication data pursuant to the communication session. Prior to sending of the communication data, the endpoint at which the data is originated places the data packets in header-reduced form, either by compressing the header parts of the data packets or by removing the header parts of the data packets. The header compression or removal operations place the data in form in conformity with service options 60 and 61, as appropriate, of the IS-835C operating specification. The data, once placed in the header-reduced form, is communicated by way of the context that is set up between the endpoints. When the data is delivered to another of the endpoints, the header parts are placed in header non-reduced form, that is to say, the header is decompressed or added to the data that is delivered.

In another aspect of the present invention, the routing node, or nodes, that receive the reservation request messages form a mapping that associates the identity of the endpoint that generates the request, the identity of another endpoint contained in the request, and the service reference identifier that identifies the service instance over which the data traffic shall be exchanged. The mapping is maintained for the duration, i.e., the life-time, of the communication session. The mapping is created, for instance, during call set-up, e.g., as part of an SIP_INVITE procedure. In contrast to a conventional mechanism, the header reduction and expansion processing is not performed at the network part, but rather the network part merely creates a mapping to route packets between the communication endpoints.

Because the header-reduction is performed at the communication endpoints, the processing operations otherwise required at the network to perform such operations are significantly reduced. The routing nodes through which the data is communicated merely maintains a mapping for permitting the routing of the data that is communicated in the header-reduced form. Reduced delays and corresponding improved communication performance is thereby provided.

In these and other aspects, therefore, apparatus, and an associated method, is provided for facilitating communication of data in header-reduced form by an endpoint node. A reservation request message generator generates a reservation request message. The reservation request message identifies an address of the endpoint node and identifies the endpoint node to be one of a header reduction originator and a header reduction terminator.

In these and other aspects, further apparatus and associated method is provided for facilitating communication of data between communication endpoint nodes through a network in header-reduced form. A network-based association creator is adapted to receive endpoint generated reservation requests generated by the communication endpoint nodes. The network based association index creator creates an association between service instance identifiers and endpoint identifiers that are contained in the endpoint-generated reservation request. The association permits header-reduced data to be routed through the network between the communication endpoint nodes.

A more complete appreciation of the present invention and the scope thereof can be obtained from the accompanying drawings that are briefly summarized below, the following detailed description of the presently-preferred embodiments of the present invention, and the appended claims.

### Brief Description of the Drawings

FIG. 1 illustrates a functional block diagram of a radio communication system in which an embodiment of the present invention is operable.

FIG. 2 illustrates a representation of the protocol stack defined by service option 61 (SO61) defined in a promulgation of the IS-835C operating specification.

FIG. 3 illustrates a protocol stack, similar to that shown in FIG. 2, but of the service option 60 (SO61) defined in the IS-835C operating specification.

FIG. 4 illustrates a partial functional block, partial pictorial representation of another implementation of a communication system in which an embodiment of the present invention is operable.

FIG. 5 illustrates a signaling flow diagram that shows the signaling flow generated pursuant to operation of an embodiment of the present invention implemented in the communication system shown in FIG. 4.

FIG. 6 illustrates the protocol stack at different nodes shown in the communication system shown in FIG. 4 pursuant to an embodiment of the present invention in which header compression is performed to place the header parts of data packets in header-reduced form.

FIG. 7 illustrates a protocol stack, similar to that shown in FIG. 6, at different nodes of the communication system shown in FIG. 4, here pursuant to an embodiment of the present invention in which header removal is performed to place the data packets in header reduced form.

FIG. 8 illustrates a partial pictorial, partial functional block diagram of a communication system of another implementation in which an embodiment of the present invention is operable.

FIG. 9 illustrates a signaling flow diagram representative of signaling generating during operation of the communication system shown in FIG. 8 pursuant to an embodiment of the present invention.

FIG. 10 illustrates the protocol stack at different nodes of the communication system shown in FIG. 8 pursuant to an embodiment of the present invention in which header compression is performed to place data packets in header-reduced form.

FIG. 11 illustrates the protocol stacks at different nodes of the communication system shown in FIG. 8 pursuant to an embodiment of the present invention in which header removal is performed to place data packets and header-reduced form.

### Detailed Description

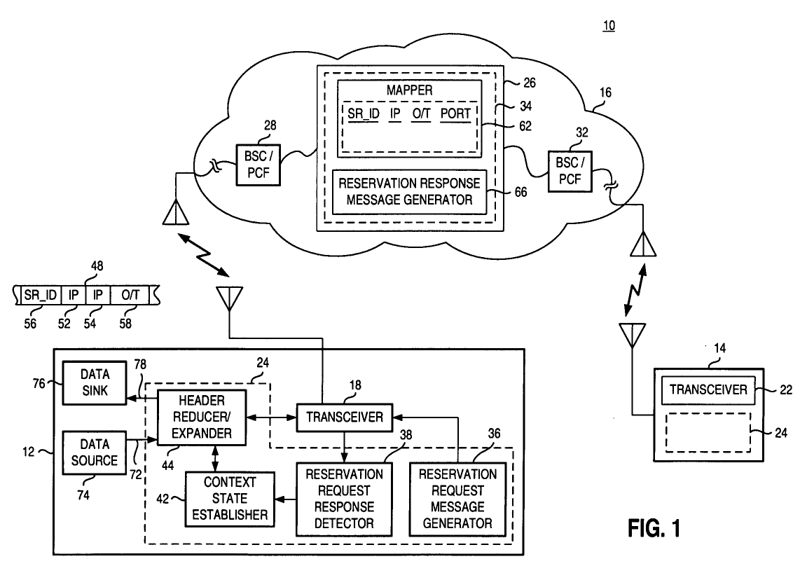

Referring first to FIG. 1, a communication system, shown generally at 10, provides for communications between communication endpoint nodes, here mobile terminals 12 and 14, by way of a radio network 16. In the exemplary implementation, the communication system operates in general conformity with the operating protocol set forth in a promulgation of the CDMA2000 operating specification and the interim standard IS-835C. While the following description of exemplary operation of an embodiment of the present invention shall be described with respect to its implementation to a CDMA2000-compliant system, the teachings of the present invention are analogously applicable in other types of communication systems in which data is communicated between a set of endpoint nodes.

Here, in particular, an exemplary communication service forming a VoIP (Voice over Internet Protocol) service is carried out. Other communication services can analogously be carried out. In a VoIP communication session, packetized data is communicated between the endpoints to effectuate telephonic communications therebetween. Here, both of the mobile terminals forming the endpoints 12 and 14 define logical nodes and include transceivers, here identified at 18 and 22, respectively. The transceivers are operable in general conformity with the operating protocols and requirements of the CDMA2000 system, in the exemplary implementation. As noted previously, the header parts of the data packets that are communicated form overhead that limits the communication capacity or throughput of the communications in the communication system. While a conventional mechanism provides for header reduction operations at the network part 16 of the communication system, performance of the header reduction operations at the network part is processing-intensive as, in a multi-user system, the need to perform the header reduction operations upon the data packets of a plurality of different communication sessions all need to be performed at the network part.

Accordingly, pursuant to an embodiment of the present invention, an apparatus 24 is provided at the endpoint nodes 12 and 14 that provides for the header reduction operations to be performed at the communication endpoints rather than at the network part 16. By delegating the header reduction operations to the communication endpoints, the processing load otherwise required of the network part is, instead, distributed to the communication endpoints. Improved scalability of system operation and improved communication performance results. The apparatus 24 embodied at the mobile terminals is functionally represented, implementable in any desired manner, including by algorithms executable by processing circuitry.

The network part 16 of the communication system is here shown to include a routing node 26, a PDSN (Packet Data Service Node) and BSC/PCF (Base Station Controller/Point Control Function) elements 28 and 32. The elements forming the network part 16 are exemplary only, here represented to show exemplary operation of an embodiment of the present invention through which data is communicated between the endpoints during a VoIP, or other, communication session.

The network part also includes apparatus, here shown at 34, operable pursuant to an embodiment of the present invention. The apparatus also is functionally represented, of which the elements of the apparatus are implementable in any desired manner, including by algorithms executable by processing circuitry. Here, the apparatus 34 is embodied at the PDSN formed of the routing node 26.

The apparatus 24 embodied at the mobile terminal 12 includes a reservation request message generator 36, a reservation request response detector 38, a context state establisher 42, and a header reducer and header expander 44. The apparatus 24 embodied at the mobile terminal 14 includes corresponding structure.

When a communication session, such as a VoIP communication session, is to be formed, a communication endpoint that is to be a party to the communication session generates a reservation request message that is communicated by the communication endpoint to the network part. The reservation request message is generated by the reservation request message generator 36 of the apparatus 24. The reservation request message 46 is formatted in general conformity with the RSVP RESV set forth in the CDMA2000/IS-835C operating specification. The request message includes the IP address 52 of the communication endpoint, the IP address 54 of another communication endpoint with which the communication session is to be effectuated, a service reference identifier 56 that identifies the communication session for which the reservation is requested, and a treatment field 58 populated with values identifying whether the endpoint forms a header reduction originator or header reduction terminator. The treatment field is populated with a first value identifying the endpoint to be a header reduction originator and is populated with a second value to indicate the endpoint to be a header reduction terminator.

The reservation request message is delivered to the network part 16 and delivered to a routing node, here the PDSN 26. The apparatus 34 embodied at the routing node includes a mapper 62 that forms a map that associates the service reference identifier and IP addresses and also identify whether the endpoint identified by the IP address forms a header reduction originator or a header reduction terminator. The map formed by the mapper 62 here identifies the service reference identifier (SR_ID) 56 together with the IP addresses 52-54 and the value 58 identifying the address as being a header reduction originator or terminator. Through the creation of the map containing the associations, access to the contents of the map is made to permit header-reduced packets to be routed between the communication endpoints.

The apparatus 34 further includes a reservation response message generator 66 that generates a response for a communication to the endpoint that generated an earlier request message.

The reservation request response detector 38 detects the delivery of the reservation response message. If the reservation response message, a reservation confirm message, acknowledges that the resources are available for the requested communication session, a context state is formed between the communication endpoints, here carried out by the context state establisher by way of which the subsequently-communicated data is transmitted. And, the apparatus further includes a header reducer/expander 44 that receives communication data, here by way of the line 72, sourced at a data source 74, that is to be communicated pursuant to a communication session. When the header reducer/expander operates to place data in header reduced form, either by compression or by truncation, the header-reduced data is provided to the transceiver 18 for communication therefrom. And, when the header reducer/expander operates upon received data, data expansion, either by decompression or reattachment of header information, is performed and the data is provided to a data sink 76 by way of the lines 78. Analogous operations are carried out by the apparatus 24 embodied at the endpoint 14.

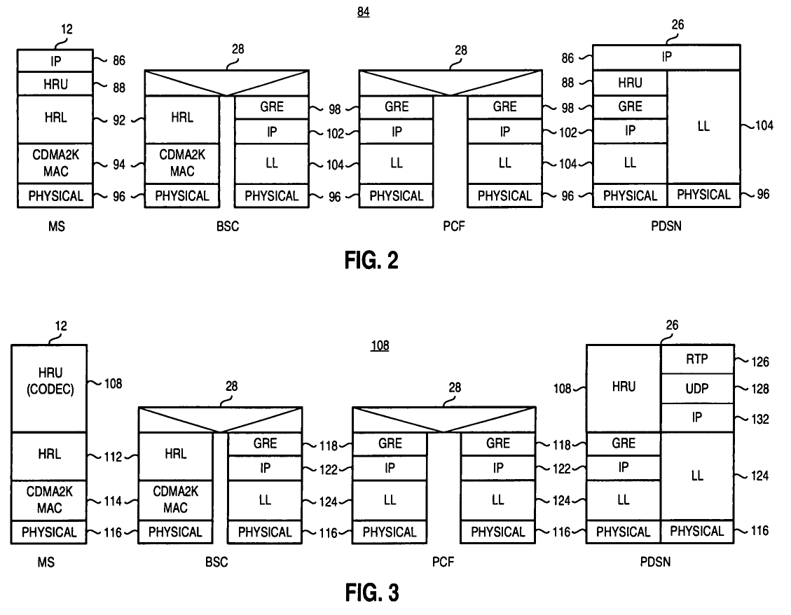

FIG. 2 illustrates a representation, shown generally at 84, of the protocol stacks of elements of the communication system 10 shown in FIG. 1 in conformity with an SO61 service operation set forth in the aforementioned IS-835C specification. The service option is defined to allow for the efficient transport of VoIP, free of the overhead that is present from PPP and RLP (Radio Link Protocol) framing on ordinary packet services. The service option 61 supports link-layer assisted (LLA) robust header compression, such as that defined in RFC 3242 and RFC 3408, that uses the physical channel timing along with re-synchronization procedures to replace the normal ROHC header in most instances. This permits IP/UDP/RTP-encapsulated (Internet Protocol/Uniform Data Protocol/Real Time Protocol-encapsulated) voice to be transmitted with minimal overhead.

The mobile terminal 12 is shown to include an IP layer 86, an HRU layer 88, an HRL layer 92, a CDMA2000 MAC layer 94, and a physical layer 96. The base station controller 28 includes the HRL, CDMA2000 MAC, and physical layers 92, 94,and 96 as well as a GRE layer 98, an IP layer 102, and an LL layer 104. The PCF, also designated at 28, also includes the GRE, IP, LL, and physical layers 98, 102, 104, and 96, respectively. And, the PDSN forming the routing node 26 includes the IP layer 86, HRU layer 88, GRE layer 98, IP layer 102, LL layer 104, and physical layers 96.

FIG. 3 illustrates a representation, shown generally at 108, of the protocol stacks at various of the elements of the communication system 10, shown in FIG. 1, pursuant to service option 60. Service option 60 supports header removal, which does not attempt to send header information over the air in a forward direction. Header removal uses physical channel timing to generate IP/UDP/RTP header information in the packet data service node forming the routing node 26 and is particularly appropriate when the mobile terminal voice application does not use IP/UDP/RTP header information.

The mobile terminal 12 includes an HRU (Codec) layer 108, an HRL layer 112, a CDMA2000 MAC layer 114, and a physical layer 116. The base station controller 28 includes the HRL, CDMA2000 MAC, and physical layers 112, 114, and 116, as well as a GRE layer 118, an IP layer 122, an LL layer 124, and the physical layer 116. The packet control function, also shown at 28, also is formed of the GRE, IP, LL, and physical layers 118, 122, 124, and 116, respectively. And, the PDSN, forming the routing node 26, includes the HRU layer 108, the GRE, IP, LL, and physical layers 118, 122, 124, and 116, and the RTP, UDP, and IP layers 126, 128 and 132.

Examination of the protocol stack shown in FIGS. 2 and 3 evidences that header reduction mechanisms require signaling and processing support. By delegating the header reduction operations to the communication endpoint nodes, the processing overhead otherwise required of the network is distributed to distribute the processing requirements rather than centralize the processing at the network part.

In order to route the packets without an IP header, i.e., reduced headers, the network routing node, here the PDSN 26 associates a data packet's source and destination address and ports to a specific identifier, e.g., an R-PID or an SR_ID value and maintains the mapping for the call corresponding to the packet. The mapping created by the mapper 62 at the routing node is created during call set-up, e.g., as part of an SIP INVITE procedure, and destroyed upon call termination. That is to say, the network simply creates a mapping to route packets to and from the mobile terminal.

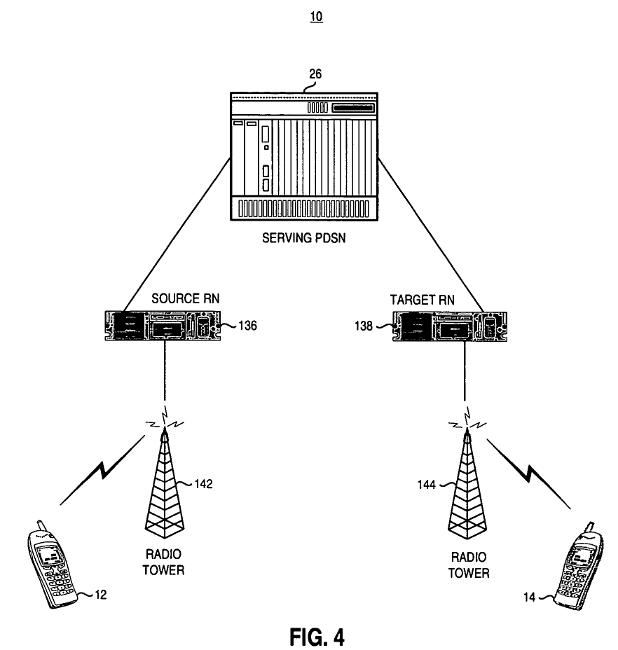

FIG. 4 illustrates a representation of the communication system 10, shown previously in FIG. 1, again showing mobile terminals 12 and 14 forming communication endpoint nodes that communicate by way of a network part, here again including a PDSN forming a routing node 26. The BSC/PCFs, shown in FIG. 1, are here represented as being parts of a source and a target radio network 136 and 138, respectively. Radio towers 142 and 144 are representative of the base stations that also form parts of the network part of the communication system.

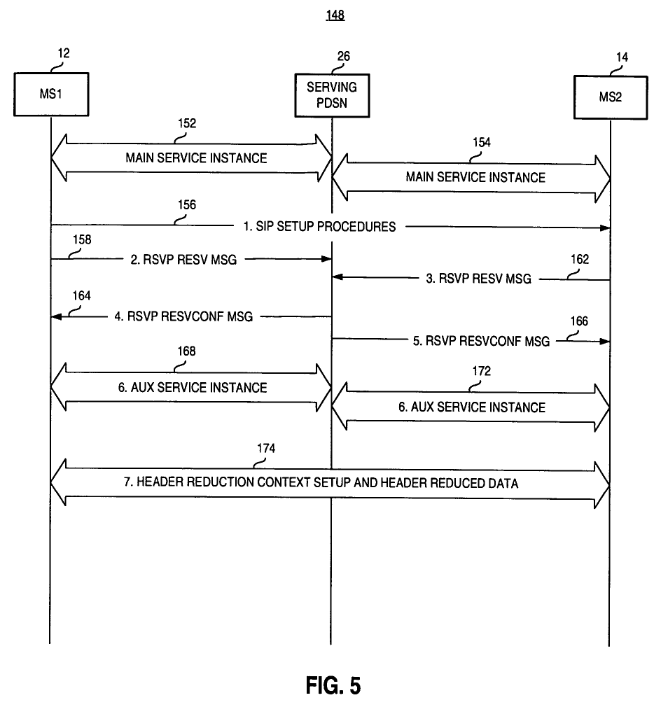

FIG. 5 illustrates a signaling flow diagram, shown generally at 148, representative of signaling between the mobile terminals 12 and 14 by way of the serving PDSN forming the routing node 26 pursuant to operation of an embodiment of the present invention. Here, description will be made with respect to the mobile terminal initiating the communications. As indicated by the segments 152 and 154, both of the mobile terminals have existing main service instances and, thus, IP addresses with the serving PDSN 26.

As indicated by the segment 156, the mobile station performs SIP signaling to set up the call pursuant to a peer-to-peer application, here a VoIP communication session. As part of the SIP SDP exchange, both sides establish the IP address and port tuples associations.

Then, and as indicated by the segment 158, the mobile terminal 12 sends an RSVP RESV request to the PDS end. The format of the message is generally defined in the IS-835C operating specification. The message includes the IP address and port information of the peer and the SR_ID identifies the service instance over which the traffic shall be exchanged. The message includes a packet filter treatment, or channel treatment value in then 3GPP2 object. Pursuant to an embodiment of the present invention, the message includes a new treatment field that is added to differentiate the header compression. In the exemplary implementation, a value of 1 is used to populate the treatment field when the node forms a header reduction originator and is of a value of 2 when the node forms a header reduction terminator. Additionally, pursuant to operation of an embodiment of the present invention, the mobile terminal and the base station controller maintain different logical RLP instances that exhibit different characteristics. And, as part of the processing of the RESV message, the packet data service node sets up the association between the SR_ID and the IP address and port information. It is additionally possible to use the main service instance to send media traffic. That is, there is no need to create a separate service instance for media (RTP) traffic. A specific SR_ID value is able to be dedicated to mean that the mobile terminal and base station controller should expect the multiplex to stream.

Similar to the message 158, the mobile terminal 14 also sends a RSV reservation request, indicated by the segment 162, to the packet data service node with the packet filter treatment indicator value set to 2 in this example.

The PDSN generates RSV reservation confirmation messages, indicated by the segments 164 and 156 for return to the mobile terminal 12 and 14, respectively if the PDSN is able to find the RP session associated with the peer and the resources for the call are available.

Then, as indicated by the segments 168 and 172, if need be, the mobile terminals set up auxiliary service instances. The PDSN 26 ensures that the SR_ID indicated in the reservation message are used in the auxiliary service instances. And, as indicated by the segment 174, the mobile terminals set up the context states for transferring the header-compressed or header-removed data to the corresponding pier.

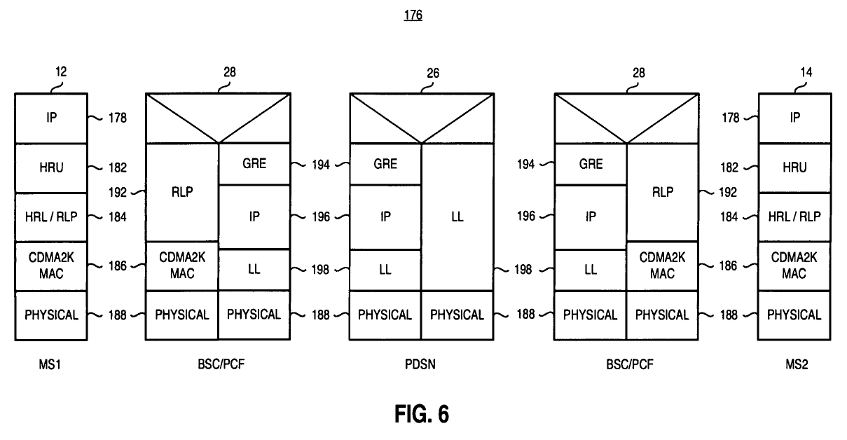

FIG. 6 illustrates a representation, shown generally at 176, of the protocol stacks at various of the network elements of the communication system 10 shown in FIGS. 1 and 4.

The mobile terminal 12 is shown to include an IP layer 178, an HRU layer 182, an HRL/RLP layer 184, a CDMA2000 MAC layer 186, and a physical layer 188. The BSC/PCF 28 includes an RLP layer 192, the CDMA2000 MAC layer 186, and the physical layer 188. The PDSN 26 also includes the GRE, IP, LL layers 194, 196, and 198, and the physical layer 188.

The BSC/PCF 28 associated with the mobile terminal 14, also includes the GRE, IP, LL, and physical layers 194, 196, 198, and 188, respectively. And, an RLP layer 192, CDMA2000 MAC layer 186, and again, physical layer 188. And, the mobile terminal is formed of logical layers 178, 182, 184, 186, and 188, corresponding to the mobile terminal 12.

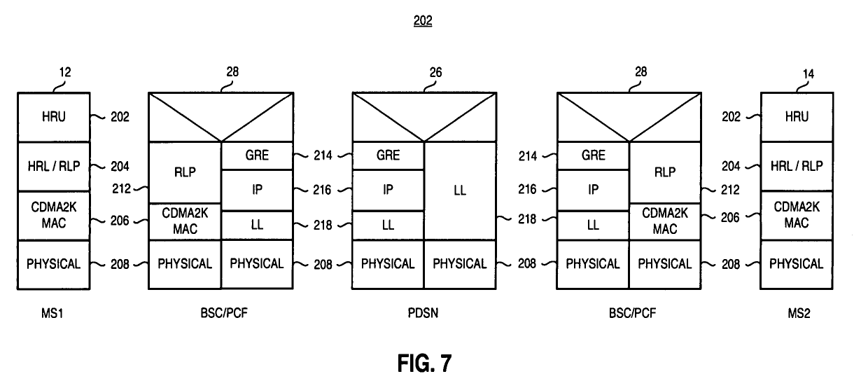

FIG. 7 illustrates a representation, shown generally at 202, of the protocol stacks of the elements of the communication system 10, similar to those shown in FIG. 6, but here in which the header reduction forms header removal. The mobile terminal 12 is here shown to include an HRU layer 204, an HRL/RLP layer 204, a CDMA2000 MAC layer 206, and a physical layer 208. The BSC/PCF 28 associated with the mobile terminal 12 includes an RLP layer 212, a CDMA2000 MAC layer 206, and the physical layer 208. The BSC/PCF is further shown to include a GRE layer 214, an IP layer 216, an LL layer 218, and the physical layer 208. The PDSN 26 also includes the GRE, IP, LL, and physical layers, 214, 216, 218, and 208, respectively. The BSC/PCF 28 associated with the mobile terminal 14 also includes the GRE, IP, LL, and physical layers 214, 216, 218, and 208. And, the node 28 includes the RLP layer 212, CDMA2000 MAC 206 layer, and the physical layer 208. And, the mobile terminal 14, analogous to the mobile terminal 12, includes layers 202, 204, 206, and 208.

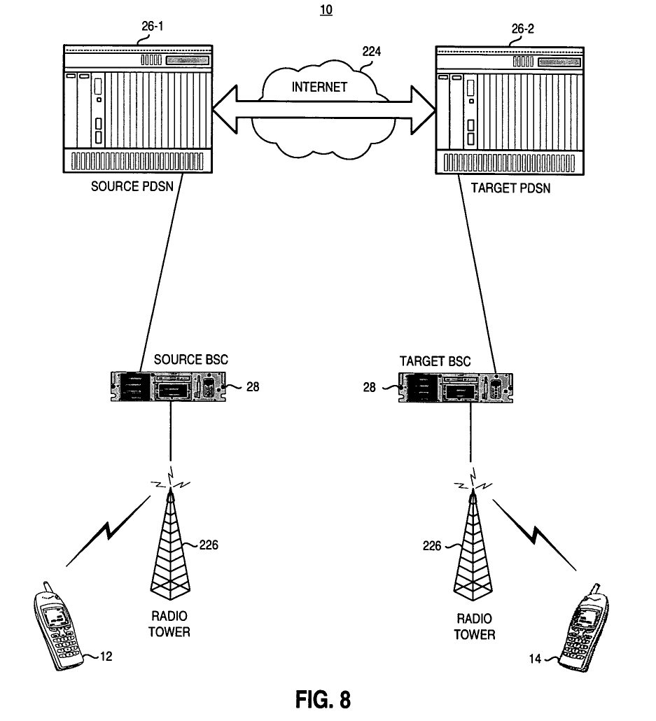

FIG. 8 illustrates a representation of the communication system 10 in which the endpoint nodes 12 and 14 are served by different packet data service nodes, here service nodes 26-1 and 26-2. The nodes 26-1 and 26-2 are interconnected by a communication medium, here the Internet 224. The base station controllers 28 associated with the respective mobile terminals are again illustrated as are radio towers 226 associated with the respective base station controllers.

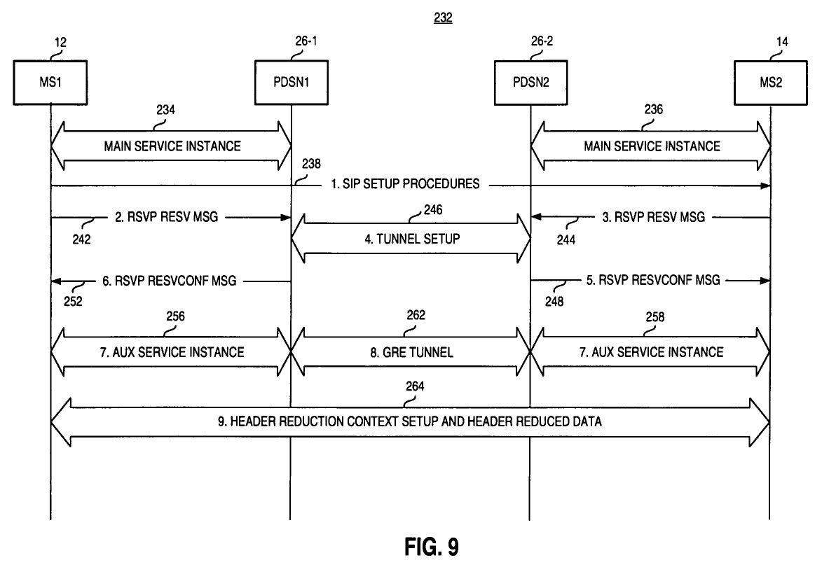

FIG. 9 illustrates a signaling flow diagram, shown generally at 232, representative of signaling generated during operation of the communication system shown in FIG. 8 pursuant to an embodiment of the present invention. Main service instances, represented by the segments 234 and 236 exist between the respective mobile terminals 12 and 14 and their associated PDSNs 26.

As indicated by the segment 238, the initiating mobile terminal, the mobile terminal 12, SIP signaling is carried out to set up the call. As part of the SIP SDP exchange, both sides establish IP addresses and port tuples association. Then, as indicated by the segments 242 and 244, the mobile terminals generate RSVP reservation messages that conform to the messages 158 and 162 described with respect to the signaling flow diagram 148 shown in FIG. 5.

In this implementation, the origination side PDSN 26-1 checks to see the destination IP address is being served by which PDSN. The PDSN 26-1 then initiates a tunnel set-up, indicated by the segment 246, with the PDSN 26-2. The tunnel set-up includes, e.g., a GRE key to identify the tunnel and an IP address and port information of the terminating mobile terminal. The PDSN 26-2 then sends a reservation confirmation message, indicated by the segment 248, to the mobile terminal 14. And, as indicated by the segment 252, the node 26-1 waits for successful tunnel creation with the PDSN 26-2. Upon successful tunnel set-up, the nodes 26-1 sends the reservation confirmation message to the mobile terminal 12.

If necessary, the mobile terminals then set up auxiliary service instances indicated by the segments 256 and 258 with the respective nodes 26-1 and 26-2. And, a GRE tunnel, indicated by the segment 262, is formed between the nodes 26-1 and 26-2 in manners similar to those by which the tunnel is set up, indicated by the segment 246. Then, and as indicated by the segment 264, context states are set up by the mobile terminals for transferring header compressed or header removed data to the pier. A tunnel management protocol is used to create, destroy, and manage the tunnels.

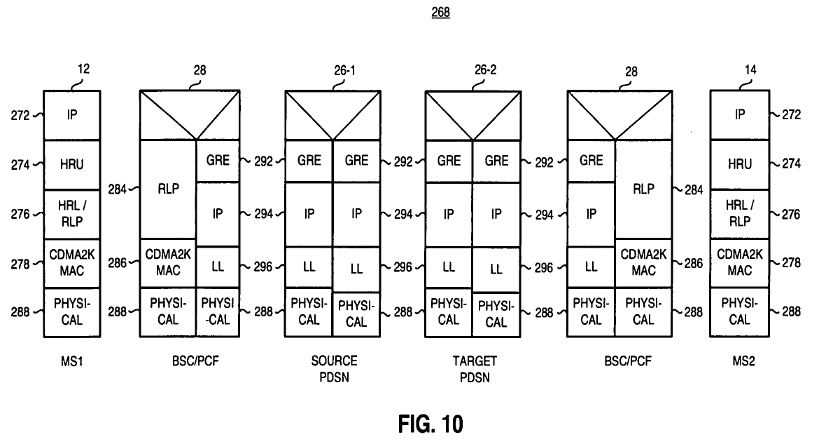

FIG. 10 illustrates a representation, shown generally at 268, of the protocol stacks of various network elements of the communication system 10 shown in FIG. 8. Here, the mobile terminals 12 and 14 are each shown to include an IP layer 272, an HRU layer 274, an HRL/RLP layer 276, a CDMA2000 MAC layer 278, and a physical layer 282. The BSC/PCFs 28 are each shown to include an RLP layer 284, a CDMA2000 MAC layer 286, and a physical layer 288. The nodes 28 are further shown to include a GRE layer 292, an IP layer 294, an LL layer 296, and the physical layer 288. And, the PDSNs 26-1 and 26-2 are each shown to include GRE, IP, LL, and physical layers 292, 294, 296, and 288. The representation 268 is representative of the protocol stacks used when header compression is performed.

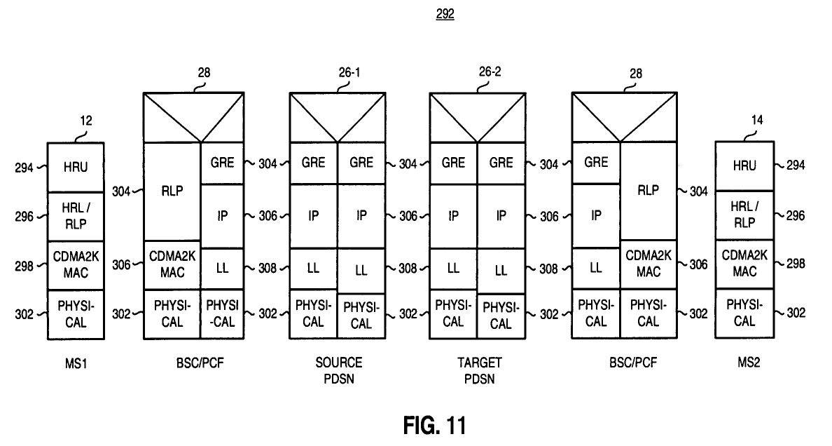

FIG. 11 illustrates a representation, shown generally at 302, of the protocol stacks of various network elements forming the communication system 10 shown in FIG. 8. The protocol stacks are representative of a scheme in which header reduction is formed by header removal.

The mobile terminals 12 and 14 each include an HRU layer 294, an HRL/RLP layer 296, a CDMA2000 MAC layer 298, and a physical layer 302. Each BSC/PCF 28 includes an RLP layer 304, a CDMA2000 MAC layer 306, and a physical layer 302. The nodes 28 further include a GRE layer 304, an IP layer 306, and LL layer 308, and the physical layer 302. And, the nodes 26-1 and 26-2 each include GRE, IP, LL, and physical layers, 304, 306, 308, and 302, respectively.

Thereby, through operation of an embodiment of the present invention, a manner is provided by which to communicate data in header-reduced form without requiring that the header reduction be performed at the network part of the communication system. Rather, the header reduction and re-expansion operations are delegated to the communication endpoint nodes. Improved communication performance is possible.

The previous descriptions are of preferred examples for implementing the invention, and the scope of the invention should not necessarily be limited by this description. The scope of the present invention is defined by the following claims.

What is claimed is:

1. Apparatus for facilitating communication of data in header-reduced form by an endpoint node, said apparatus comprising:
a reservation request message generator for generating a reservation request message, the reservation request message identifying an address of the endpoint node and identifying the endpoint node to be one of a header reduction originator and a header reduction terminator.

2. The apparatus of claim 1 further comprising a reservation response detector for detecting a reservation response message to the reservation request message, the reservation response message confirming communication resource availability for the communication of the data.

3. The apparatus of claim 2 further comprising a context state establisher for establishing a header-reduced context for communicating the data in the header reduced form.

4. The apparatus of claim 1 wherein the reservation request message generated by said reservation request message generator comprises an RSVP RESERVATION request message containing a treatment field identifying the endpoint node to be the one of header reduction originator and the header reduction terminator.

5. The apparatus of claim 4 wherein the value populating the treatment field of the RSVP RESERVATION request is of a first level when the endpoint node forms the header reduction originator and is of a second level when the endpoint node forms the header reduction terminator.

6. The apparatus of claim 1 wherein the address of the endpoint node that identifies the endpoint node in the reservation request comprises an Internet Protocol (IP) address assigned to the endpoint node.

7. The apparatus of claim 1 wherein the address of the endpoint node that identifies the endpoint node in the reservation request is obtained by the endpoint node pursuant to a call setup procedure.

8. The apparatus of claim 3 further comprising a header compressor for compressing the data that is to be communicated by the endpoint node into the header reduced form.

9. The apparatus of claim 3 further comprising a header decompressor for decompressing the data that is communicated to the endpoint node into header decompressed form.

10. The apparatus of claim 1 wherein the reservation request message generated by said reservation request message generator further includes a service reference identifier that identifies a service instance pursuant to which the data is to be communicated.

11. Apparatus for facilitating communication of data between communication endpoint nodes through a network in header-reduced form, said apparatus comprising:
a network-based association creator adapted to receive endpoint-generated reservation requests generated by the communication endpoint nodes, said network-based association index creator for creating an association between service instance identifiers and endpoint identifiers that are contained in the endpoint-generated reservation requests, the association permitting header-reduced data to be routed through the network between the communication endpoint nodes.

12. A method for facilitating communication of data in header-reduced form between endpoint nodes, said method comprising the operations of:
placing the data in header-reduced form at a first one of the communication endpoints;
setting-up a context between the endpoint nodes; and
sending the data, in the header-reduced form, by the first one of the endpoint nodes by way of the context.

13. The method of claim 12 further comprising the operation of generating a reservation request message at the first one of the endpoint nodes, the reservation request message identifying an address of the first one of the endpoint nodes and identifying the endpoint node to be a header reduction originator.

14. The method of claim 13 further comprising the operation of detecting a reservation response message responsive to the reservation request message.

15. The method of claim 13 further comprising the operation of associating the address of the first one of the endpoint nodes with a service reference identifier.

16. The method of claim 13 further comprising the operation of generating a reservation request message at a second one of the endpoint nodes, the reservation request message identifying an address of the second one of the endpoint nodes and identifying the second one of the endpoint nodes to be a header reduction terminator.

17. The method of claim 16 further comprising the operation of associating the address of the second one of the endpoint nodes with a service reference identifier.

18. The method of claim 17 further comprising the operation of associating the first one of the endpoint nodes with the service reference identifier.

19. The method of claim 12 wherein said operation of placing the data in header-reduced form comprises removing Internet Protocol header information from the data.

20. The method of claim 12 further comprising the operation of placing the data in header-nonreduced form when delivered to a second one of the endpoint nodes.
